(19) United States
(12) Patent Application Publication
(10) Pub. No.: US 2005/0257887 A1
(43) Pub. Date: Nov. 24, 2005

(54) Method and apparatus for melt-bonded materials for tackification of dry fabric preforms

(76) Inventor: Thomas Karl Tsotsis, Orange, CA (US)

Correspondence Address: HARNESS, DICKEY & PIERCE, P.L.C., P.O. BOX 828, BLOOMFIELD HILLS, MI, 48303, US

(21) Appl. No.: 10/852,713

(22) Filed: May 24, 2004

(51) Int. Cl. B32B 31/20

(52) U.S. Cl. 156/308.2; 264/258; 156/583.1

(57) ABSTRACT

A dry fiber preform having a plurality of fiber layers held together via one or more non-woven, thermoplastic veils. The thermoplastic veils are heated and slightly melted during manufacture of the preform, and serve to hold the various woven fiber layers of the preform adjacent one another without stitching, clamping or tackifiers that could otherwise disrupt the flow of resin when the preform is subjected to a subsequently performed resin transfer molding process. The thermoplastic veils also serve to significantly improve the post-impact strength of the preform. The use of the thermoplastic veils allows the woven fiber layers to be secured to one another on the fly as the fiber layers are placed over a mold or tool and heated.

### FIELD OF THE INVENTION

This invention relates to preforms infused with resin that are used in liquid-molding processes like resin transfer molding (RTM), vacuum-assisted RTM (VARTM), resin film infusion (RFI), etc., and more specifically to an apparatus and method for tackifying preforms prior to resin infusion during the molding process.

### BACKGROUND OF THE INVENTION

Tacking large preforms to prepare them for use in a liquid-molding process is presently done by clamping two or more distinct layers that have previously been tackified with spray-on tackifiers or by stitching together the various layers. However, clamping can require large forces that may distort the fabric. Stitching, on the other hand, may impart fiber damage and may not be desirable for certain part designs. The use of tackifiers can also disrupt resin flow paths and create defects. Tackifiers also have limited effective lifetimes that limit the shelf life of the preform.

In view of the forgoing, it would be highly desirable to provide a fiber preform, and a method of manufacturing the same, that allows a plurality of fabric layers to be secured together more effectively and without the drawbacks of previous methods for securing independent fiber layers together. More specifically it would be highly desirable to provide a fiber preform as comprised of a plurality of distinct, fibrous layers that are held together by a non-woven material that can be partially melted as the fiber layers are layed down on a mold or tool. The non-woven layer would preferably also act as a “toughening” interlayer to impart additional damage resistance to composites fabricated from the preform. Such an arrangement would obviate the need for the application of sticky tackifiers, glues or mechanical means such as threads, darts, etc. during preform assembly, when using an automated laydown process.

### SUMMARY OF THE INVENTION

The present invention is directed to an apparatus and method for forming a fiber preform having a non-woven, thermoplastic interlayer or veil between at least a pair of fibrous layers of the preform. The non-woven, thermoplastic veil can be partially melted during preform assembly as the two fiber layers are formed against one another to act as a means for holding the fiber layers together. The present invention obviates the need for the application for spray-on tackifiers, glues or mechanical means such as threads, darts, etc., during preform assembly. The non-woven thermoplastic veil also acts as a toughening layer to impart significant additional impact damage resistance to composite structures made using the multi-layered fibrous preform. A significant advantage is that the use of the thermoplastic veil does not dissolve into the resin used during a subsequently performed liquid-molding process, and therefore does not migrate; thus, it remains at the area it was initially disposed at. Moreover, the thermoplastic veil does not adversely affect the resultant mechanical properties of the finished, molded part made from the preform. The thickness of the thermoplastic veil can also be varied to provide a greater or lesser degree of impact damage tolerance to better suit the needs of specific applications and parts.

The features, functions, and advantages can be achieved independently in various embodiments of the present inventions or may be combined in yet other embodiments.

### BRIEF DESCRIPTION OF THE DRAWINGS

The present invention will become more fully understood from the detailed description and the accompanying drawings, wherein:

FIG. 1 is a highly enlarged, cross-sectional view of a portion of a preform made in accordance with a preferred embodiment of the present invention;

FIG. 2 is an exploded perspective view of the various layers of the preform shown in FIG. 1;

FIG. 3 is a simplified view of the layers of FIG. 3 being secured together by a heated roller;

FIG. 4 is a simplified side view of an alternative preferred embodiment of the present invention;

FIG. 5 is a simplified side view of two of the layers of material shown in FIG. 3 being secured together to form a multilayer preform.

### DETAILED DESCRIPTION OF THE PREFERRED EMBODIMENTS

The following description of the preferred embodiment(s) is merely exemplary in nature and is in no way intended to limit the invention, its application, or uses.

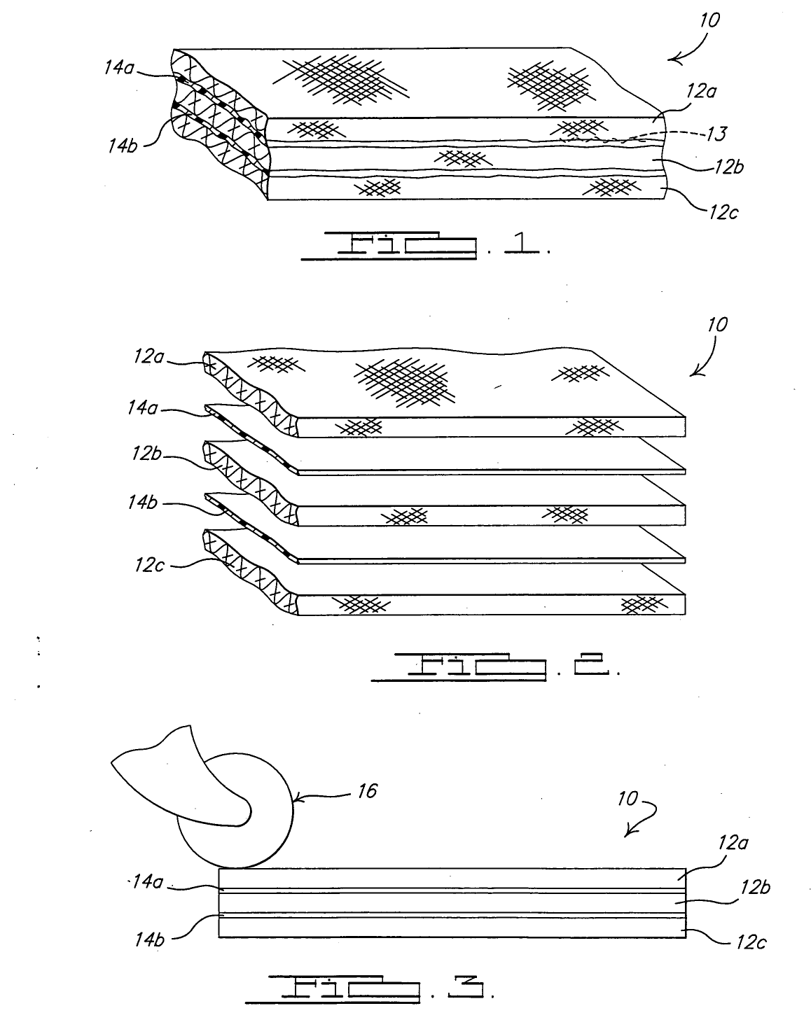

Referring to FIGS. 1 and 2, there is shown a fibrous preform 10 in accordance with a preferred embodiment of the present invention. The fibrous preform 10 is comprised of a plurality of layers of fibers 12a, 12b and 12c that may be unidirectional or multiaxial, woven or nonwoven, that are held together by a plurality of non-woven, thermoplastic layers or “veils” 14a, 14b that are integral to each fiber layer. Thus each fibrous layer 12a, 12b, and 12c comprises a combination of structural fibers. At least a sub-plurality of the fibrous layers 12 preferably include the thermoplastic veils 14a, 14b, etc. However, it will be appreciated that each fibrous layer 12 may include at least one thermoplastic veil 14. Furthermore, each fibrous layer may itself be comprised of multiple fiber and thermoplastic layers as long as at least one of the outer surfaces of the fibrous layer is coated by a thermoplastic layer. The thermoplastic veils 14 are integrated into the fibrous layers 12 during the production of the fabric by melt-bonding, knitting (i.e., stitching 13), or other mechanical means.

It will be appreciated immediately, however, that while the preform 10 shown in FIG. 1 comprises three distinct fiber layers, that a greater or lesser plurality of fiber layers may be incorporated. One of the non-woven thermoplastic veils 14, however, is disposed between adjacent layers 12. In this example, fibrous layer 12c does not require a thermoplastic veil to be secured to layer 12b because of the presence of thermoplastic veil 14b. The layers 12 may be comprised of unidirectional fibers or fibers that are oriented randomly or in any desired pattern. In preferred forms the layers 12 may comprise carbon fibers, glass fibers, or ceramic fibers as the principal structural fibers. The non-woven, thermoplastic veils 14 are comprised of a thermoplastic material having a low-melting point, preferably within the range of about 300° F. to 350° F., and an areal weight of typically between 1-50 grams/square meter, and more preferably between about 5-15 grams/square meter. The non-woven, thermoplastic veils 14 are heated such as by a heated roller, hot air implement, a laser, or any other suitable implement during manufacture of the preform 10 to slightly melt the veils 14a and 14b such that the veils 14a and 14b become tacky and adhere adjacent ones of the layers 12 to one another to prevent movement of the layers 12. In this manner, the preform 10 can be handled as a single, large preform for maintaining the layers 12 secured (i.e., tacked) together by the non-woven thermoplastic veils 14a and 14b.

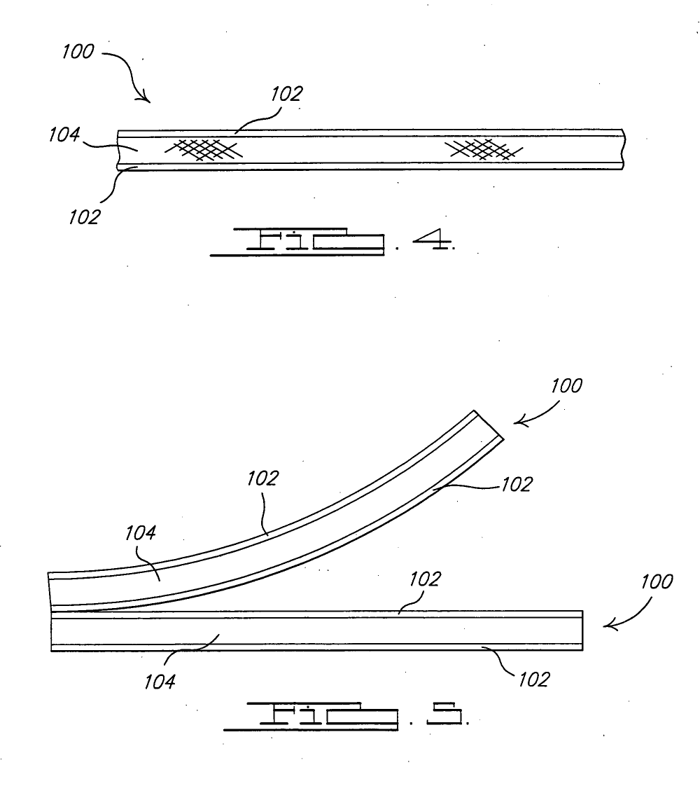

FIG. 3 illustrates the preform 10 prior to the layers 12 being secured to one another. An important benefit of the veils 14a and 14b is the added post-impact strength that they provide to the finished preform 10. The thickness (i.e., weight) of one or each of the fibrous preforms 12 can be tailored as needed to provide the desired degree of post-impact strength to the preform 10. However, the amount of each of the non-woven thermoplastic veils 14 used is also preferably only large enough so as to be able to hold the various fibrous layers 12 in their desired locations without any adverse effect on the resultant mechanical properties of the finished part, and also without adversely affecting the drapeability of the fiber preform 10. The thickness of each of the fiber layers 12 can also be varied to provide a fiber preform that will suit the needs of a specific part or application. In FIG. 3, the non-woven, thermoplastic veils 14a and 14b are slightly melted through the use of a heated roller 16 to provide the necessary heat to partially melt the veils 14a and 14b such that they can adhere to the fiber layers 12a, 12b and 12c.

A principal advantage of the present invention is that the thermoplastic veil(s) used do not dissolve into the resin during a subsequent resin transfer molding process, and thus does not migrate during the subsequent molding process. Rather, each thermoplastic veil stays at the location at which it was initially positioned into the fibrous layers of the preform.

Referring to FIG. 4, a fiber preform 100 in accordance with an alternative preferred embodiment of the present invention is shown. Preform 100 differs from preform 10 in that a non-woven, thermoplastic interlayer or veil 102 is disposed on each opposing outer surface of a woven, fiber layer 104. Veils 102 may be attached to layer 104 by heating with a roller, laser, hot-air gun or other implement to a degree that sufficiently softens or partially melts the interlayers 102 such that they stick to the layer 104. Non-woven, thermoplastic veils 102 may vary in weight as needed and to also toughen the preform 100 and improve its post-impact strength. The thermoplastic veils 102 could also be held in place by stitching, rather than melt-bonding.

Referring to FIG. 5, two fiber preforms 100 are illustrated being secured together. Heat is applied to layer 104 to sufficiently soften or partially melt the veils 102 such that the layers 104 are secured together to form a multilayer fibrous preform.

The fibrous preform of the present invention thus does not require any clamping, stitching or the use of any spray-on tackifiers to hold the various fibrous layers of the preform in place. Eliminating the use of tackifiers ensures that resin flow paths in the preform will not be disrupted during the subsequently performed resin transfer molding process. The preform of the present invention further has an extended shelf life as compared to a preform incorporating a tackifier. An important benefit is that the non-woven thermoplastic veils 14 and 102 significantly improve the impact damage tolerance of the preform and improve its post-impact strength. Furthermore, the ability to secure various layers together “on the fly” as the fiber layers are being laid up on a mold reduces the manufacturing time for producing a molded part from the preform 10.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

1. A method for forming a fiber preform having a plurality of fibrous layers, comprising:
providing a first fibrous layer that incorporates a thermoplastic veil on at least one outer surface;
providing a second fibrous layer that incorporates a thermoplastic veil on at least one outer surface;
applying heat to at least one of said fibrous layers as said fibrous layers are positioned adjacent one another during a preform laydown process, said heat being sufficient to at least soften said thermoplastic veils to tack said fibrous layers together as said fiber preform is constructed, and said thermoplastic veils providing improved impact damage tolerance.

2. The method of claim 1, wherein each said thermoplastic veil has a weight sufficiently low to not interfere with the ability to infuse the preform with a resin in a subsequent resin-transfer-molding process.

3. The method of claim 2, wherein each said thermoplastic veil has an areal weight of between about 1 and 50 grams/square meter.

4. The method of claim 2, wherein each said thermoplastic veil has an areal weight of between about 5 and 15 grams/square meter.

5. The method of claim 1, wherein providing first and second fibrous preforms comprises providing preforms having carbon fibers as the principal structural fiber.

6. The method of claim 1, wherein providing first and second fibrous preforms comprises providing preforms having glass fibers as the principal structural fiber.

7. The method of claim 1, wherein providing first and second fibrous preforms comprises providing preforms having ceramic fibers as the principal structural fiber.

8. A method for tackifying a pair of fibrous layers together to form a fibrous preform, comprising:
positioning a first fibrous layer so that a thermoplastic veil secured thereto faces, and is in contact with, a second fibrous layer; and
heating at least one of the first and second fibrous layers to partially melt the thermoplastic veil so that it becomes tacky and holds the first and second fibrous layers together; said thermoplastic veil providing improved impact damage tolerance.

9. The method of claim 8, wherein placing the thermoplastic veil in between the adjacent fibrous layers comprises disposing a thermoplastic veil having an areal weight of between about 1 and 50 grams/square meter.

10. The method of claim 8, wherein placing the thermoplastic veil in between the adjacent fibrous layers comprises disposing a thermoplastic veil having an areal weight of between about 5 and 15 grams/square meter.

11. A method for tackifying a pair of fibrous layers together to form a fibrous preform, comprising:
providing a first fibrous layer having a first thermoplastic veil;
providing a second fibrous layer having a second thermoplastic veil, positioning the first fibrous layer so that the first thermoplastic veil faces and is in contact with a second fibrous layer; and
heating at least one of the first and second fibrous layers to partially melt the first thermoplastic veil so that it becomes tacky and holds the first and second fibrous layers together; said thermoplastic veils providing improved impact damage tolerance to the preform.

12. The method of claim 11, further comprising placing the first and second fibrous layers in contact with each other such that the first and second thermoplastic veils are in contact with each other, prior to heating one of said fibrous layers.

13. The method of claim 11, further comprising securing a pair of thermoplastic veils on opposite surfaces of each of the fibrous layers.

14. The method of claim 11, further comprising securing at least one of the thermoplastic veils to its respective said fibrous layer by stitching.

15. The method of claim 11, further comprising providing at least one of the thermoplastic veils with an areal weight between 1-50 grams/square meter.

16. The method of claim 11, further comprising providing at least one of the thermoplastic veils with an areal weight between 5-15 grams/square meter.

17. A system for tackifying a plurality of independent fibrous layers to form a fiber preform, comprising:
a first fibrous layer that incorporates a thermoplastic veil on at least one outer surface;
a second fibrous layer; and
a device for melting the thermoplastic in between said fibrous layers and tackifying said fibrous layers to form a multilayered fiber preform.

18. The system of claim 17, wherein the thermoplastic veil has an areal weight of between about 1 and 50 grams/square meter.

19. The system of claim 17, wherein the thermoplastic veil has an areal weight of between about 5 and 15 grams/square meter.
